(19) United States
(12) Patent Application Publication
(10) Pub. No.: US 2024/0158000 A1
(43) Pub. Date: May 16, 2024

(54) TOOTHED BELT PULLEY FOR A TOOTHED BELT DRIVE OF A MOTOR VEHICLE STEERING SYSTEM, STEERING DRIVE FOR A MOTOR VEHICLE STEERING SYSTEM, AND STEERING SYSTEM FOR A MOTOR VEHICLE

(71) Applicants: thyssenkrupp Presta AG, Eschen (LI); thyssenkrupp AG, Essen (DE)

(72) Inventors: Alexander PETSCH, Lienz (CH); András ILLÉS, Gams (CH); Iago SILVA LOPEZ, Buchs (CH); Qani MUSTAFI, Landquart (CH)

(73) Assignees: thyssenkrupp Presta AG, Eschen (LI); thyssenkrupp AG, Essen (DE)

(21) Appl. No.: 18/508,025

(22) Filed: Nov. 13, 2023

(30) Foreign Application Priority Data
Nov. 14, 2022 (DE) 10 2022 130 072.2

(51) Int. Cl. B62D 5/04

(52) U.S. Cl. CPC B62D 5/0403; B62D 5/0424; B62D 5/0445

(57) ABSTRACT

A toothed belt pulley for a toothed belt drive of a motor vehicle steering system, having a gear ring which has an externally encircling toothing and is attached to a hub body. The gear ring is formed as a plastically formed metallic formed part and the hub body comprises a plastics-material part.

### CROSS REFERENCE TO RELATED APPLICATION

This application is a U.S. Non-Provisional that claims priority to German Patent Application No. DE 10 2022 130 072.2, filed Nov. 14, 2022, the entire content of which is incorporated herein by reference.

### FIELD

The present disclosure relates to a toothed belt pulley for a toothed belt drive of a motor vehicle steering system.

### BACKGROUND

The disclosure relates to a toothed belt pulley for a toothed belt drive of a motor vehicle steering system, comprising a gear ring which has an externally encircling toothing and is attached to a hub body. A steering drive for a steering system of a motor vehicle with such a toothed belt pulley and a steering system for a motor vehicle are also the subject matter of the disclosure.

In an electromechanical steering system, at least one electric steering drive is provided for providing a motorized actuating force, which is exerted as a steering force for generating a steering angle on steerable wheels. The steering drive has an electric motor which is actuated depending on steering commands—for example by manual steering inputs or automatically provided control signals. The motor torque is converted via a gearbox for adjusting the steerable wheels.

In the state of the art, for example from DE 10 2011 012311 A1, a steering drive is known in which a belt drive between the motor and an actuator element which is operatively connected to a steerable wheel is incorporated so as to drive a spindle drive. A toothed belt pulley is attached to the motor shaft as a drive wheel which, via a revolving belt, is coupled in terms of drive to a toothed belt pulley which is coaxially connected to an axially supported spindle nut in which a threaded spindle engages. The latter can be moved axially in a linear manner by the rotational drive of the spindle nut, and serves as an actuator element.

The spindle nut is connected in a rotationally fixed manner to a hub body of the toothed belt pulley. From DE 10 2006 059 946 A1 an embodiment is known in which the gear ring made of a plastics material is attached to the hub body made of a metal. The disadvantage is the relatively high wear of the gear ring and the complex production of the hub body.

Thus, a need exists to reduce the wear and the manufacturing complexity.

### BRIEF DESCRIPTION OF THE FIGURES

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 shows a schematic perspective partial view of a steering system according to the disclosure.

FIG. 2 shows an enlarged view of the steering drive of the steering system according to the disclosure.

FIG. 3 shows a longitudinal section through the spindle drive of the steering drive of FIG. 2.

FIG. 4 shows the spindle drive of FIG. 3 in a schematically exploded illustration.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure relates to a toothed belt pulley for a toothed belt drive of a motor vehicle steering system, comprising a gear ring which has an externally encircling toothing and is attached to a hub body. A steering drive for a steering system of a motor vehicle with such a toothed belt pulley and a steering system for a motor vehicle are also the subject matter of the invention.

In a toothed belt pulley for a toothed belt drive of a motor vehicle steering system, comprising a gear ring which has an externally encircling toothing and is attached to a hub body, it is provided according to the disclosure that the toothed ring is formed as a plastic formed metal formed part and the hub body comprises a plastics-material part. The toothing is preferably designed as helical toothing.

According to the disclosure, the toothed belt pulley is configured as a composite component, wherein the gear ring is formed of a metal which is established coaxially on a hub body which may be configured entirely from a plastics material or may at least comprise a plastics-material part. The hub body or a plastics-material part of the hub body may be formed as an adapter body, which is coaxially connected to a further functional element.

One advantage of the metallic gear ring is that the wear is less than with a plastics-material gear ring. Another advantage is that production by means of plastic forming processes such as for example pressing, extruding or the like is able to be implemented in a particularly economical and cost-effective manner, whereby the production complexity is significantly lower than, for example, in subtractive machining, sintering or casting processes.

The coaxially attached hub body made of plastics material enables tolerance compensation and centring of the gear ring with relatively little complexity in production. The lower weight compared to the known metallic hub bodies is also advantageous.

Another advantage of plastic forming is that a continuous structure is generated in the metallic material, which ensures high strength. As a result, the gear ring can be made so as to be relatively thin-walled, which can save material and weight.

It is preferred that the formed part comprises an extruded part. The gear ring can have a basic shape which is substantially in the form of a tubular section or in the form of a sleeve. This makes it possible to proceed from a blank in the form of a tubular section during production, which can be cut to length from standard available pipe material. This blank can be plastically formed economically by means of extrusion, for example hollow-reverse extrusion, to form an extruded part that forms the gear ring.

Preferably, it can be provided that the formed part is formed from a steel material. Steel can be processed economically using plastic forming, and guarantees low wear. Due to the high strength, which can be additionally increased by the plastic forming, a low material thickness of the gear ring and correspondingly a low weight can be implemented in an advantageous manner. For example, a steel material with the material number E235+N (1.0308) can be used.

It can be advantageously provided that the gear ring has a flanged wheel. The flanged wheel forms an axial delimitation of the toothing and can be formed as an encircling, radially projecting annular projection. Conjointly with the toothing, this flanged wheel can be plastically moulded so as to be integral on the formed part. The plastic forming for the production of the gear ring, including the toothing and the flanged wheel, can be carried out in one operation, so that economical production is made possible.

It is advantageous that the hub body has a thermoplastic plastics material. Thermoplastic plastics materials such as polypropylene (PP), polyoxymethylene (POM) are distinguished by favourable material properties such as high elasticity, strength, weight and the like, and can be processed economically.

An advantageous embodiment can provide that the hub body is injected into the gear ring. The hub body can be manufactured by plastic injection-moulding, whereby a substance-to-substance bond to the gear ring is generated at the same time. This enables economical and cost-effective production.

It is possible that the hub body is connected in a force-fitting and/or form-fitting manner to the gear ring. The hub body can, for example, be provided as a separate plastics-material part, for example as an injection-moulded part, which is pressed into the gear ring. As a result, a force-fitting connection can be generated. Additionally or alternatively, form-fitting elements may be provided, which positively interlock when joining the hub body to the gear ring, for example during press-fitting or else during injection by injection-moulding.

It can be provided that the hub body is connected to a spindle nut.

The hub body herein is disposed coaxially with the thread axis or spindle axis on the spindle nut, in which spindle nut a threaded spindle can engage so as to form a spindle drive.

In the above-mentioned embodiment, it is possible that the hub body is bonded/connected to the spindle nut in a substance-to-substance and/or force-fitting and/or form-fitting manner. For example, the hub body may be press-fitted to the spindle nut, or the spindle nut may be embedded in the thermoplastic plastics-material by injection.

The disclosure furthermore comprises a steering drive for a steering system of a motor vehicle, which has an electric motor which is operatively connected to an actuator element via a toothed belt drive, wherein the toothed belt drive has a toothed belt which revolves around toothed belt pulleys, wherein it is provided according to the disclosure that at least one toothed belt pulley is configured according to one of the above-described embodiments or combinations thereof.

The toothed belt pulleys can preferably comprise a drive pulley attached to the motor shaft of a motor, and a driven pulley which is coupled, for example, to an actuator for adjusting steerable wheels of a motor vehicle. The high wear resistance, the low weight and the economical production of the toothed belt pulley according to the disclosure are advantageous.

It can be provided in an advantageous embodiment that provided is a threaded spindle which in the direction of its spindle axis (threaded axis) is axially displaceable in a housing and engages in a spindle nut rotatably mounted in a bearing assembly in the housing, wherein the spindle nut is connected to the hub body of the toothed belt pulley. This implements a spindle drive which can be integrated in or combined with a known rack-and-pinion steering gear of an auxiliary power steering system or a steer-by-wire steering system.

The disclosure furthermore comprises a steering system for a motor vehicle, wherein it is provided according to the disclosure that the steering drive is configured according to one of the above-described embodiments or combinations thereof. The threaded spindle is coupled to steerable wheels via tie rods.

In the various figures, identical parts are always denoted by the same reference signs and will therefore typically also be in each case referred to or mentioned only once.

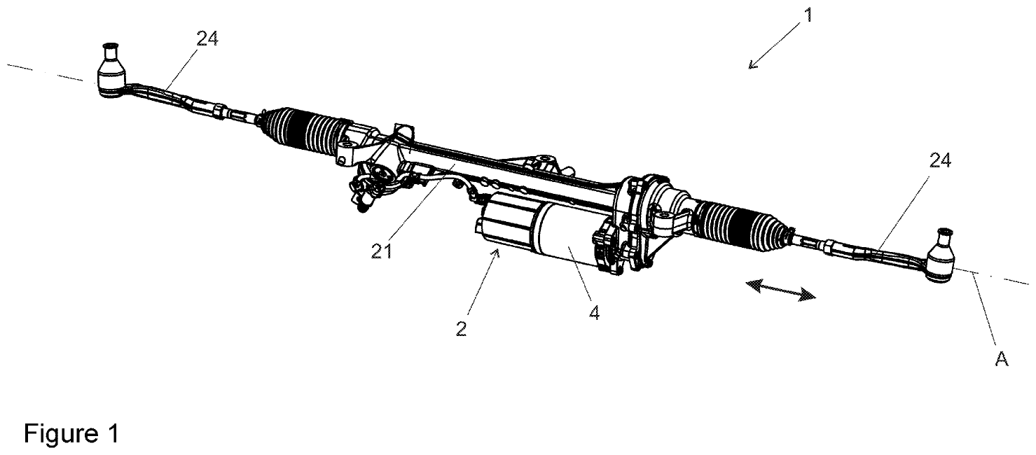

FIG. 1 shows a steering system 1 according to the disclosure in a perspective view. It comprises a steering drive 2 according to the disclosure, which is designed as a steering gear and has a housing 21 which is elongate in the direction of an axis A.

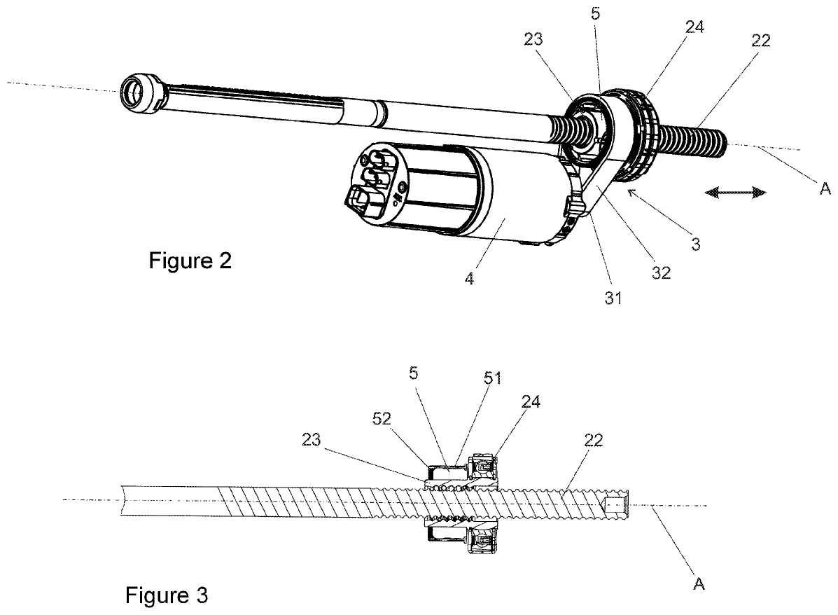

FIG. 2 shows in an enlarged view the steering drive 2, wherein the housing 21 is omitted, exposing a view of a toothed belt drive 3 according to the disclosure.

A threaded spindle 22 is mounted in the housing 21 so as to be longitudinally displaceable in the direction of the axis A, which is identical to the spindle axis, as indicated by the double arrow in FIG. 2. The threaded spindle 22 engages in a spindle nut 23 which is rotatably mounted in the housing 21 in a bearing 24 and supported axially in the direction of the axis A. Thereby, a spindle drive is formed, which by the rotational drive of the spindle nut 23 by means of the motor 4 enables an axial linear displacement of the threaded spindle 22.

The threaded spindle 22 is connected to tie rods 24, which are axially guided out of the housing 21 on both sides, and which at their free end regions are articulated on steering knuckles of steerable wheels, not illustrated here, of a vehicle.

The steering drive 2 comprises an electric motor 4, which for driving is coupled to the toothed belt drive 3. Accordingly, a rotational drive of the spindle nut 23 can take place by way of the toothed belt drive 3, whereby a linear displacement of the threaded spindle 22 and thereby a steering angle of the steered wheels is generated.

The toothed belt drive 3 comprises a first, smaller toothed belt pulley 31, which forms a drive wheel and is fastened in a rotationally fixed manner to the motor shaft of the motor 4. A second, larger toothed belt pulley 5, as an output wheel, is connected in a rotationally fixed manner to the spindle nut 23. As a traction means of the belt drive 3, a toothed belt 32 revolves about the toothed belt pulleys 31 and 5.

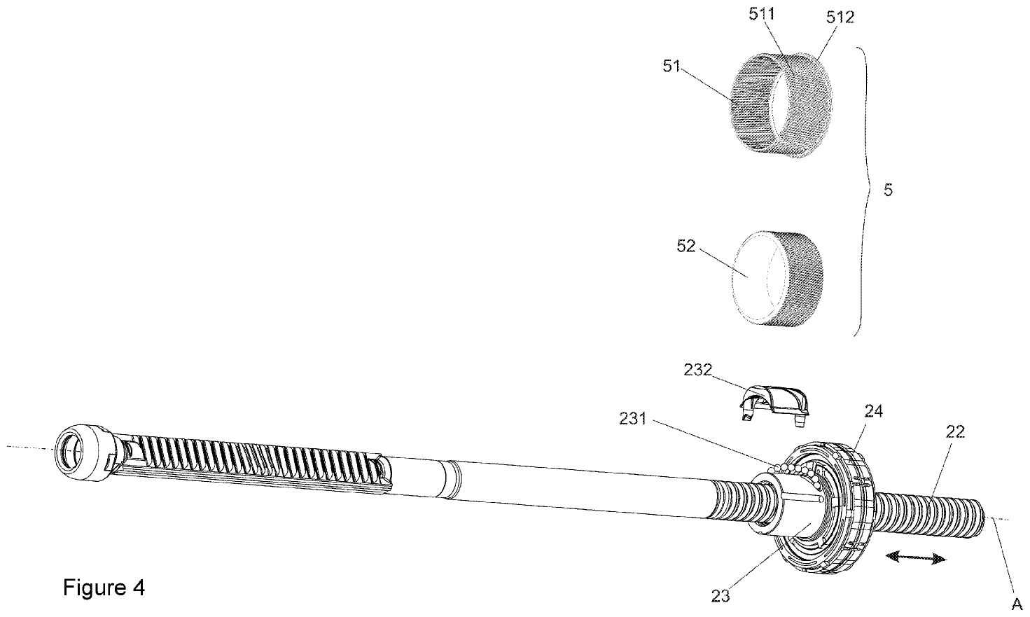

FIG. 3 shows a longitudinal section along the axis A through the spindle drive, and FIG. 4 shows a schematically exploded perspective view.

The toothed belt pulley 5 is designed according to the disclosure and has a gear ring 51 which is coaxially connected to a hub body 52.

The gear ring 51 is formed as a plastically formed part, for example as an extruded part, preferably made of steel. It has on its outer circumference a toothing 511, and an integral flanged wheel 512 which is moulded on the former during plastic forming and projects radially beyond the toothing 511.

The hub body 52 is configured to be sleeve-shaped and made from a plastics material, preferably from a thermoplastic polymer. It is fixedly bonded/connected coaxially to the gear ring 51, for example in a substance-to-substance manner by overmoulding by plastic injection-moulding.

Alternatively, the connection can be established in a force-fitting and/or form-fitting manner by press-fitting or the like.

In the example shown, the spindle nut 23 is formed as a ball screw nut, and has balls 231 and a deflection housing 232.

The hub body 52 is connected in a rotationally fixed manner to the spindle nut 23, for example in a force-fitting and/or form-fitting manner by axial press-fitting.

For use in an auxiliary power steering system, a rack 25 in which a pinion—not illustrated here—of a manually rotatable steering shaft engages can be connected to the threaded spindle 22.

### LIST OF REFERENCES

1 Steering system
2 Steering drive
21 Housing
22 Threaded spindle
23 Spindle nut
231 Ball
232 Deflection housing
24 Bearing
25 Rack
3 Toothed belt drive
31 Toothed belt pulley
32 Toothed belt
4 Motor
5 Toothed belt pulley
51 Gear ring
511 Toothing
512 Flanged wheel
52 Hub body
A Axis

What is claimed is:

1. A toothed belt pulley for a toothed belt drive of a motor vehicle steering system, comprising:
a gear ring having an externally encircling toothing and is attached to a hub body, wherein the gear ring is formed as a plastically formed metallic formed part and the hub body comprises a plastics-material part.

2. The toothed belt pulley of claim 1, wherein the formed part includes an extruded part.

3. The toothed belt pulley of claim 1, wherein the formed part is formed from a steel material.

4. The toothed belt pulley of claim 1, wherein the gear ring includes a flanged wheel.

5. The toothed belt pulley of claim 1, wherein the hub body comprises a thermoplastic plastics material.

6. The toothed belt pulley of claim 5, wherein the hub body is injected into the gear ring.

7. The toothed belt pulley of claim 1, wherein the hub body is connected to the gear ring in a force-fitting and/or form-fitting manner.

8. The toothed belt pulley of claim 1, wherein the hub body is connected to a spindle nut.

9. The toothed belt pulley of claim 8, wherein the hub body is bonded/connected to the spindle nut in a substance-to-substance and/or force-fitting and/or form-fitting manner.

10. A steering drive for a steering system of a motor vehicle, which has an electric motor comprising:
an operative connection from the motor to an actuator element via a toothed belt drive, wherein the toothed belt drive has a toothed belt which revolves about toothed belt pulleys, wherein at least one toothed belt pulley is of claim 1.

11. The steering drive of claim 10, further comprising a threaded spindle which in the direction of its spindle axis (A) is axially displaceable in a housing and engages in a spindle nut rotatably mounted in a bearing assembly in the housing, wherein the spindle nut is connected to the hub body of the toothed belt pulley.

12. A steering system for a motor vehicle, comprising:
a steering drive of having a toothed belt pulley including:
a gear ring having an externally encircling toothing and is attached to a hub body, wherein the gear ring is formed as a plastically formed metallic formed part and the hub body comprises a plastics-material part.
